(19) United States
(12) Patent Application Publication
(10) Pub. No.: US 2026/0286467 A1
(43) Pub. Date: Sep. 24, 2026

(54) METHOD FOR RECYCLING RARE EARTH ELEMENT

(71) Applicants: KABUSHIKI KAISHA TOSHIBA, Kawasaki-shi (JP); NITERRA MATERIALS CO., LTD., Yokohama-shi (JP)

(72) Inventors: Jian Cao, Yokohama Kanagawa (JP); Maho Hayase, Yokohama Kanagawa (JP); Masaaki Hirakawa, Yokohama Kanagawa (JP); Hiroyasu Kondo, Yokohama Kanagawa (JP); Kenji Arai, Yokohama Kanagawa (JP)

(21) Appl. No.: 19/570,760

(22) Filed: Mar. 18, 2026

(30) Foreign Application Priority Data
Mar. 21, 2025 (JP) 2025-047306

(51) Int. Cl. C22B 59/00; C22B 3/22; C22B 7/00

(52) U.S. Cl. CPC C22B 59/00; C22B 3/22; C22B 7/007

(57) ABSTRACT

According to one embodiment, a method for recycling a rare earth element which includes bringing a ceramic sintered body including at least one selected from the group consisting of silicon nitride, silicon carbide, and zirconium oxide, and at least one rare earth element selected from the group consisting of Y, Er, Ce, and La into contact with an aqueous solution including fluoride ions and hydrogen ions in a pressure atmosphere at a temperature of from 100° C. to 400° C. to generate a fluoride of the rare earth element, and separating the fluoride of the rare earth element by solid-liquid separation.

### CROSS-REFERENCE TO RELATED APPLICATION

This application is based upon and claiming the benefit of priority from Japanese Patent Application No. 2025-047306, filed Mar. 21, 2025, the entire contents of which are incorporated herein by reference.

### FIELD

Embodiments described herein relate generally to a method for recycling a rare earth element.

### BACKGROUND

As ceramic materials, silicon nitride ceramic sintered bodies, aluminum nitride ceramic sintered bodies, silicon carbide ceramic sintered bodies, titanium carbide ceramic sintered bodies, and the like are known. Among the ceramic sintered bodies described above, the silicon nitride ceramic sintered bodies are particularly excellent in hardness and toughness. It is required to establish a technique for recycling rare earth elements from auxiliary agents contained in these ceramic sintered bodies.

### BRIEF DESCRIPTION OF DRAWINGS

FIG. 1 is a flowchart showing an example of a flow of a method for recycling a rare earth element according to an embodiment.

### DETAILED DESCRIPTION

According to one embodiment, a method for recycling a rare earth element is provided. The method including
bringing a ceramic sintered body including at least one selected from the group consisting of silicon nitride, silicon carbide, and zirconium oxide, and at least one rare earth element selected from the group consisting of Y, Er, Ce, and La into contact with an aqueous solution including fluoride ions and hydrogen ions in a pressure atmosphere at a temperature of from 100° C. to 400° C. to generate a fluoride of the rare earth element; and
separating the fluoride of the rare earth element by solid-liquid separation.

A method for recycling a rare earth element according to an embodiment will be described with reference to the drawings.

The method for recycling a rare earth element according to the embodiment includes:
bringing a ceramic sintered body containing at least one selected from the group consisting of silicon nitride, silicon carbide, and zirconium oxide, and at least one rare earth element selected from the group consisting of Y, Er, Ce, and La into contact with an aqueous solution containing fluoride ions and hydrogen ions (hereinafter referred to as treatment liquid) in a pressure atmosphere at a temperature of from 100° C. to 400° C. to generate a fluoride of the rare earth element; and
obtaining the fluoride of the rare earth element by solid-liquid separation.

First, a ceramic sintered body will be described. The ceramic sintered body is not particularly limited as long as it can be treated with a treatment liquid. The ceramic sintered body may be a waste material or a material scheduled to be discarded. The ceramic sintered body may be used or unused.

The ceramic sintered body contains a main component and an auxiliary agent. In the ceramic sintered body, a content of the main component is larger than a content of the auxiliary agent.

The main component of the ceramic sintered body is formed of a ceramic constituent material such as silicon nitride (for example, Si₃N₄), silicon carbide (for example, SiC), or zirconium oxide (for example, ZrO₂). In addition, the main component is a material contained in the largest amount in the ceramic sintered body. For example, silicon nitride is contained in the largest amount in the silicon nitride sintered body. Silicon carbide is contained in the largest amount in the silicon carbide sintered body, and zirconium oxide is contained in the largest amount in the zirconium oxide sintered body. The silicon nitride sintered body also includes sialon (SiAlON). The ceramic constituent material has high solubility in the treatment liquid. Therefore, the main component can be transferred to a liquid phase by treating the ceramic sintered body with the treatment liquid. The main component may be formed of one ceramic constituent material or may be formed of two or more ceramic constituent materials.

The auxiliary agent of the ceramic sintered body contains at least one rare earth element (referred to as a first rare earth element) selected from the group consisting of Y, Er, Ce, and La. Each rare earth element of Y, Er, Ce, or La can be present in the ceramic sintered body in the form of an oxide. Examples of the oxide include yttrium oxide (for example, Y₂O₃), erbium oxide (for example, Er₂O₃), Ce oxide (for example, CeO₂), and lanthanum oxide (for example, La₂O₃). The oxide also includes a composite oxide. Examples of the composite oxide include yttrium aluminum oxide and yttrium magnesium oxide. Each rare earth element of Y, Er, Ce, or La forms a fluoride and deposits in the treatment liquid. Therefore, by treating the ceramic sintered body with the treatment liquid, each rare earth element of Y, Er, Ce, or La can be obtained in the form of a fluoride. The auxiliary agent may contain a rare earth element (referred to as a second rare earth element) other than Y, Er, Ce, and La. Examples of the second rare earth element can include Sc, Pr, Nd, Pm, Sm, Eu, Gd, Tb, Dy, Ho, Tm, Yb, and Lu. The second rare earth element can be present in the ceramic sintered body in the form of an oxide.

The auxiliary agent may contain a metal element other than the rare earth element. Examples of the metal element other than the rare earth element include Ti, Mg, Hf, Zr, Al, and Sr. The metal element can be present in the ceramic sintered body as an oxide. Examples of the oxide include titanium oxide (for example, TiO₂), magnesium oxide (for example, MgO), hafnium oxide (for example, HfO₂), Zr oxide, Al oxide, and Sr oxide. The type of the auxiliary agent contained in the sintered body may be one or two or more. The auxiliary agent can be present, for example, at a crystal grain boundary of a ceramic such as silicon nitride.

A desirable ceramic sintered body is a ceramic sintered body having a first composition containing a main component containing silicon nitride and a rare earth element constituted by at least one of Y or Er. It is desirable to remove a composition containing Mg or Al from the first composition. The ceramic sintered body containing silicon nitride has high hardness and toughness, but can be efficiently dissolved in the treatment liquid by the present method. In addition, Y and Er can be deposited as a fluoride insoluble in the treatment liquid. Therefore, Y and Er can be selectively separated and recycled from the ceramic sintered body containing silicon nitride and a plurality of auxiliary agents containing metals, and Y and Er can be recycled at a high recycle rate and at a low cost. In a case where the ceramic sintered body having a composition containing a main component containing silicon nitride and a rare earth element constituted by at least one of Y or Er contains at least one element of Mg or Al, Mg and Al are deposited as a fluoride insoluble in the treatment liquid, and thus, there is a possibility that Mg and Al may be mixed in a fluoride of the rare earth element which is a target for recycle. In a case where Mg or Al is deposited, a step of separating from the rare earth element is performed. In a case where Mg or Al is contained, a step of removing Mg or Al may be performed in advance.

A shape of the ceramic sintered body is not limited, but may be, for example, a plate shape, a rod shape, a spherical shape, a lump shape, or a granular shape. The shape of the ceramic sintered body may be the same, but may be a mixture of a plurality of shapes.

The ceramic sintered body may be pulverized or unpulverized. Examples of the pulverization method can include mechanical pulverization and electric pulse pulverization. The mechanical pulverization is crushing by applying at least one or more forces of compression, impact, and shear. Examples of the mechanical pulverization can include pulverization by a dry pulverizer. Examples of the dry pulverization can include a roll crusher, a jaw crusher, and a ball mill. A shape of the powder of the ceramic sintered body is not limited, and examples thereof can include a granular shape, a fibrous shape, and a scaly shape. A size of the powder of the ceramic sintered body is desirably 1 mm or less. A more preferable range is from 0.05 mm to 1 mm. The size of the powder of the ceramic sintered body can be measured by, for example, sieving.

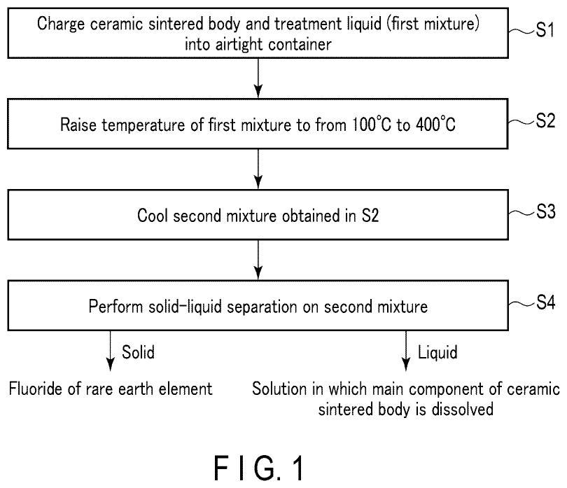

The method shown in FIG. 1 includes steps S1 to S4. Each step will be described below.

### <Step S1>

A ceramic sintered body and an aqueous solution (treatment liquid) containing fluoride ions and hydrogen ions are charged into an airtight container.

In the treatment liquid, examples of the fluoride ions include F⁻. Examples of the hydrogen ions include H⁺. Examples of the treatment liquid include an aqueous hydrofluoric acid solution, a mixed aqueous solution containing NH₄F and H₂SO₄, and a mixed aqueous solution containing NH₄F and HCl. The aqueous hydrofluoric acid solution is also called an aqueous solution of hydrogen fluoride (HF). The aqueous hydrofluoric acid solution is a kind of acidic liquid.

An acid concentration of the treatment liquid is desirably from 1% by weight to 49% by weight. By setting the acid concentration to 1% by weight or more, it is possible to promote dissolution of the main component in the treatment liquid. It is also possible to promote generation of a fluoride of the first rare earth element. If the acid concentration is higher than 49% by weight, the fluoride of the rare earth metal to be recycled is dissolved, which may affect the recycle rate. In order to promote the dissolution of the main component while securing the safety and cost, the acid concentration is desirably set to from 1% by weight to 49% by weight.

The ceramic sintered body and the treatment liquid may be charged sequentially or simultaneously into the airtight container. In addition, the ceramic sintered body and the treatment liquid are mixed by, for example, a method of immersing the ceramic sintered body in the treatment liquid, or a method of adding the treatment liquid to the ceramic sintered body. The mixing may be performed in advance before charging into the airtight container, or may be performed in the airtight container after charging into the airtight container.

The ceramic sintered body and the treatment liquid can be charged into the airtight container, for example, in air. As a result, the ceramic sintered body and the treatment liquid are exposed to air in the airtight container.

The airtight container may be any container as long as it can airtightly store a first mixture including the ceramic sintered body and the treatment liquid. A storage portion and a lid may be separate members, or the lid may be integrated with the storage portion. Examples of a material constituting the airtight container can include a metal, an alloy, and a fluororesin (for example, polytetrafluoroethylene (PTFE)). Examples of the airtight container can include a PTFE container of model HU series of reaction decomposition containers for high pressure manufactured by SAN-AI Kagaku Co. Ltd. (sanai-kagaku.co.jp). The PTFE airtight container is resistant both to acid solutions and to high temperature and high pressure.

### <Step S2>

A temperature of the mixture (first mixture) of the ceramic sintered body and the treatment liquid contained in the airtight container is raised to a range of from 100° C. to 400° C.

By setting the temperature of the first mixture to the range of from 100° C. to 400° C., a water vapor pressure in the airtight container can be increased to increase an internal pressure of the airtight container. The internal pressure is higher than atmospheric pressure. The pressure atmosphere contains air and water vapor. In a case where the first mixture is exposed to a pressure atmosphere having a temperature of from 100° C. to 400° C., dissolution of the main component and the auxiliary agent containing a metal other than the first rare earth element in the ceramic sintered body in the treatment liquid can be promoted. In addition, a reaction between the first rare earth element and the treatment liquid can be promoted.

The internal pressure of the airtight container is desirably from 0.23 MPa to 40 MPa. By setting the internal pressure to this range, it is possible to promote dissolution of the main component and the auxiliary agent containing the metal other than the first rare earth element in the ceramic sintered body in the treatment liquid. In addition, a reaction between the first rare earth element and the treatment liquid can be promoted.

In a pressure atmosphere having a temperature of from 100° C. to 400° C. and from 0.23 MPa to 40 MPa, generation of a supercritical fluid can be avoided, and therefore dissolution of the main component and the auxiliary agent containing the metal other than the first rare earth element in the ceramic sintered body in the treatment liquid can be promoted. In addition, a reaction between the first rare earth element and the treatment liquid can be promoted.

A time for treatment in the pressure atmosphere at a temperature of from 100° C. to 400° C. is desirably from 5 hours to 150 hours. By setting the treatment time to the above range, it is possible to increase amounts of the main component and the auxiliary agent containing the metal other than the first rare earth element in the ceramic sintered body to be dissolved in the treatment liquid while suppressing the cost required for the treatment. It is also possible to promote generation of a fluoride of the first rare earth element.

Since the main component in the ceramic sintered body is dissolved in the treatment liquid in step S2, the ceramic sintered body can be collapsed. By dissolution of silicon nitride, for example, SiF₆²⁻ ions and the like are generated. On the other hand, the auxiliary agent containing the first rare earth element reacts with the treatment liquid to form a fluoride. Specific examples of the fluoride include ErF₃ and YF₃. The fluoride is insoluble in the treatment liquid. Therefore, the fluoride is present as a solid in the treatment liquid. Therefore, in step S2, a mixture (referred to as a second mixture) containing the treatment liquid, the main component dissolved (extracted) in the treatment liquid, and the fluoride (solid) of the first rare earth element is obtained. The treatment liquid may contain ions of a metal other than the first rare earth element which is contained in an auxiliary agent.

### <Step S3>

The second mixture obtained in step S2 is cooled.

The cooling can be performed, for example, by air-cooling or water-cooling the airtight container.

The cooling is desirably performed until a temperature of the second mixture reaches room temperature or lower (for example, 25° C. or lower). By cooling to room temperature or lower, the contents can be safely taken out from the container.

### <Step S4>

Solid-liquid separation is performed on the second mixture.

The fluoride of the first rare earth element is separated and obtained from the second mixture by solid-liquid separation. The solid-liquid separation is performed, for example, by filtration. The recycled fluoride is rinsed (for example, washed with water) and dried as necessary. The recycled fluoride may be mechanically pulverized. The mechanical pulverization is crushing by applying at least one or more forces of compression, impact, and shear. The recycled fluoride can be used as a raw material for an optical device.

Examples of the method for separating the first rare earth element from the recycled fluoride include an acid dissolution method, an electrolytic deposition method, an ion exchange resin method, a solvent extraction method, a precipitation separation method, a chromatographic separation method, and a magnet separation method. Any one method or a plurality of methods can be combined to perform separation and collecting.

In a case where Er and Y are used as the first rare earth elements, Er or Y may be separated and recycled from the recycled fluoride. For this recycle, for example, at least one of sulfuric acid or perchloric acid can be used. Examples of recycling methods are described in <1> to <3>.

<1> ErF₃ is dissolved by bringing an aqueous sulfuric acid solution into contact with the recycled fluoride, and YF₃ remaining as a solid without being dissolved is obtained.

<2> YF₃ is dissolved by bringing an aqueous perchloric acid solution into contact with the recycled fluoride, and ErF₃ remaining as a solid without being dissolved is obtained.

<3> The recycled fluoride is dissolved in an acid to generate a carbonate of the first rare earth element, and then an oxide of the target rare earth element is obtained by roasting.

A liquid separated from the second mixture by the solid-liquid separation may contain ions of the elements constituting the ceramic, and ions of the metals other than the first rare earth element. This liquid may be discarded.

According to the recycling method according to the embodiment described above, a ceramic sintered body containing at least one selected from the group consisting of silicon nitride, silicon carbide, and zirconium oxide, and at least one rare earth element (first rare earth element) selected from the group consisting of Y, Er, Ce, and La is brought into contact with an aqueous solution containing fluoride ions and hydrogen ions (treatment liquid) in a pressure atmosphere at a temperature of from 100° C. to 400° C. to generate a fluoride of the first rare earth element. The fluoride of the first rare earth element deposits as a solid in the treatment liquid. On the other hand, the main component of the ceramic sintered body is dissolved in the treatment liquid. As a result, the structure of the ceramic sintered body can be collapsed. Therefore, the first rare earth element can be recycled as a fluoride by subjecting the mixture generated in the above step to solid-liquid separation. Therefore, according to the method of the embodiment, only the first rare earth element can be separated in one step of treatment with an aqueous solution containing fluoride ions and hydrogen ions. In other words, since the separation between the first rare earth element and the other non-rare earth element can be omitted, burden related to the separation process can be reduced. The fluoride of the first rare earth element can be used as a raw material for an optical device. Therefore, the dissolution separation treatment of the fluoride of the first rare earth element can be omitted, and the cost related to the recycle can be reduced. The main component and other auxiliary agents, which are not targets for recycle, can be moved to the liquid phase by treatment with the treatment liquid. By discarding the obtained liquid, the cost of recycle can be reduced. Since most of the main component of the ceramic sintered body can be dissolved in the treatment liquid, a step of pulverizing the ceramic sintered body before the treatment with the treatment liquid can be omitted. As described above, a method for recycling a rare earth element at low cost and high recycle rate can be realized.

### EXAMPLES

Examples will be described later.

### EXAMPLES

A waste material of a silicon nitride ceramic sintered body (0.0367 g) was prepared. The composition of the silicon nitride ceramic sintered body is as follows. The main component is Si₃N₄. The auxiliary agent includes Er₂O₃, Y₂O₃, HfO₂, and TiO₂.

The waste material of the silicon nitride ceramic sintered body had a size in a range of 106 μm to 500 μm.

The waste material of the silicon nitride ceramic sintered body and 10 g of a 10% by weight aqueous hydrofluoric acid solution as the treatment liquid (acidic liquid) were placed in an airtight container (PTFE airtight container of model HU-25 manufactured by SAN-AI Kagaku Co. Ltd.) having an internal volume of 25 mL, and then mixed by stirring. Thereafter, the airtight container was sealed under atmospheric pressure.

In a case where the temperature in the airtight container was raised to 146° C. by heating the airtight container in an oven, the internal pressure reached 0.55 MPa. The treatment at set high temperature and high pressure was performed for 24 hours. Thereafter, the temperature in the airtight container was cooled to 25° C. Table 1 shows the type, liquid amount, and concentration (acid concentration) of the treatment liquid, the size of the sintered body, the amount of the sintered body, and the treatment time.

Next, a mixture (second mixture) of a solid and a liquid in the airtight container was obtained. The second mixture was subjected to solid-liquid separation by filtration. Each of the obtained filtrate and solid was analyzed by a method described below.

For the filtrate, particles in the filtrate were removed using a syringe filter having a pore size of 0.22 μm. Then, the metal ion concentration of each of Er³⁺, Y³⁺, Hf⁴⁺, Ti⁴⁺, and Si⁴⁺ in the filtrate was measured by inductively coupled plasma mass spectrometry (ICP-MS). The measured value is compared with the reference concentration, and the value (%) of each metal ion concentration of the filtrate in a case where the reference concentration is 100% is shown as the solubility (%) of each metal element in Table 2. The reference concentration was calculated for each type of Si₃N₄ as the main component and each auxiliary agent. Each reference concentration is each metal ion concentration (mol/L) in a case where the main component and each auxiliary agent contained in the amount (0.0367 g) of the silicon nitride ceramic sintered body used in Examples are each completely dissolved in 10 g of a 10% by weight aqueous hydrofluoric acid solution.

TABLE 1

| | Acidic liquid | Liquid | | | Amount (g) | |
|---|---|---|---|---|---|---|
| | (treatment | amount | Concentration | Size of | of sintered | Treatment |
| Table 1 | liquid) | (g) | (wt %) | sintered body | body | time (h) |
| Example | Aqueous | 10.0 | 10 | 106 μm to | 0.0367 | 24 |
| | hydrofluoric | | | 500 μm | | |
| | acid solution | | | | | |
| Comparative | Aqueous | 10.0 | 10 | 106 μm to | 0.0367 | 24 |
| Example 1 | hydrochloric | | | 500 μm | | |
| | acid solution | | | | | |
| Comparative | Aqueous nitric | 10.0 | 10 | 106 μm to | 0.0367 | 24 |
| Example 2 | acid solution | | | 500 μm | | |
| Comparative | Aqueous sulfuric | 10.0 | 10 | 106 μm to | 0.0367 | 24 |
| Example 3 | acid solution | | | 500 μm | | |

TABLE 2

| | Er | Y | Hf | Ti | Si |
|---|---|---|---|---|---|
| | Solubility | Solubility | Solubility | Solubility | Solubility |
| Example | 0.0% | 0.0% | 103.7% | 125.7% | 137% |
| Comparative | 104.7% | 102.9% | 55.6% | 123.1% | 1.2% |
| Example 1 | | | | | |
| Comparative | 129.7% | 128.2% | 26.0% | 83.5% | 2.7% |
| Example 2 | | | | | |
| Comparative | 87.7% | 88.1% | 27.4% | 97.9% | 3.0% |
| Example 3 | | | | | |

As is apparent from the results shown in Table 2, it is found that Si₃N₄ as the main component and HfO₂ and TiO₂ as the auxiliary agents were dissolved in the aqueous hydrofluoric acid solution by the hydrofluoric acid treatment of Examples. The aqueous hydrofluoric acid solution after the treatment contained SiF₆²⁻, Ti ions, and the like. In addition, since both the Er solubility and the Y solubility of Er₂O₃ and Y₂O₃ as the auxiliary agents were 0%, it is found that Er₂O₃ and Y₂O₃ were not dissolved in the aqueous hydrofluoric acid solution.

On the other hand, the solid was washed with 100 mL of ultrapure water and then dried by heating at 120° C. for 20 minutes. The dried solid was observed by SEM-EDX (energy dispersive X-ray spectroscopy (SEM)). From a secondary electron image and a reflected electron image (both magnification: 1000 times) by a scanning electron microscope (SEM), it was confirmed that no rod-shaped crystal of β-Si₃NA was present in the solid. Results of mapping analysis by EDX are shown in Table 3.

TABLE 3
Table 3: EDX analysis results of Example 1
Table 3: EDX analysis results of Example 1

| Element | C | O | Si | N | F | Y | Er | Hf | Ti |
|---|---|---|---|---|---|---|---|---|---|
| Atomic | 2.1 | 2.9 | 0.0 | 0.0 | 60.2 | 12.6 | 22.0 | 0.0 | 0.0 |
| concentration | | | | | | | | | |
| (%) | | | | | | | | | |

As is clear from the results shown in Table 3, atomic concentrations of F, Y, and Er are higher than the atomic concentrations of the other elements. From this result and the previous ICP-MS analysis result, it was confirmed that Er and Y ions were deposited as fluorides such as ErF₃ and YF₃ in the treatment liquid by the hydrofluoric acid treatment of Examples. In addition, since the atomic concentrations of Si, N, Hf, and Ti were 0%, it was confirmed that Si₃N₄ as the main component and HfO₂ and TiO₂ as the auxiliary agents were dissolved in the aqueous hydrofluoric acid solution by the hydrofluoric acid treatment of Examples.

### Comparative Example 1

High-temperature and high-pressure treatment and solid-liquid separation were performed in the same manner as in Examples except that 10 g of a 10% by weight aqueous hydrochloric acid solution was used as the acidic liquid instead of the aqueous hydrofluoric acid solution. Table 1 shows the type, liquid amount, and concentration (acid concentration) of the treatment liquid, the size of the sintered body, the amount of the sintered body, and the treatment time.

Each of the filtrate and solid obtained by the solid-liquid separation was analyzed by a method described below.

For the filtrate, particles in the filtrate were removed in the same manner as in Examples. Next, the metal ion concentrations of Er³⁺, Y³⁺, Hf⁴⁺, Ti⁴⁺, and Si⁴⁺ in the filtrate were measured by ICP-MS. The measured value is compared with the reference concentration, and the value (%) of each metal ion concentration of the filtrate in a case where the reference concentration is 100% is shown as the solubility (%) of each metal element in Table 2. The reference concentration was calculated for each type of Si₃N₄ as the main component and each auxiliary agent. Each reference concentration is each metal ion concentration (mol/L) in a case where the main component and each auxiliary agent contained in the amount (0.0367 g) of the silicon nitride ceramic sintered body used in Examples are each completely dissolved in 10 g of a 10% by weight aqueous hydrochloric acid solution.

As is apparent from the results shown in Table 2, it is found that Er₂O₃, Y₂O₃, HfO₂ and TiO₂ as the auxiliary agents were dissolved in the aqueous hydrochloric acid solution by the hydrochloric acid treatment of Comparative Example 1, but that Si₃N₄ as the main component was hardly dissolved in the hydrochloric acid.

On the other hand, the solid was washed and dried by heating in the same manner as in Examples, and then subjected to SEM-EDX observation. From the secondary electron image and the reflected electron image (both magnification: 1000 times) by SEM, it was confirmed that a rod-shaped crystal of β-Si₃N₄ remained. In an electron image obtained by magnifying the reflected electron image 5000 times, mapping analysis by EDX was performed on each of a gray portion where the rod-shaped crystal was present and a white portion where the rod-shaped crystal was not present, and the results are shown in Table 4.

TABLE 4
Table 4: EDX analysis results of Comparative Example 1
Table 4: EDX analysis results of Comparative Example 1

| Table 4 | Element | C | O | Si | N | Er | Y | Hf | Ti |
|---|---|---|---|---|---|---|---|---|---|
| Gray rod- | Atomic | 5.1 | 0.6 | 39.5 | 54.1 | 0.1 | 0.0 | 0.0 | 0.6 |
| shaped crystal | concentration | | | | | | | | |
| | (%) | | | | | | | | |
| White | Atomic | 4.8 | 3.7 | 38.0 | 44.0 | 0.1 | 0.0 | 0.0 | 9.4 |
| portion | concentration | | | | | | | | |
| | (%) | | | | | | | | |

As is clear from the results shown in Table 4, in the gray portion, a total atomic concentration of Si and N exceeds 90%, and it is found that the gray portion is almost constituted by silicon nitride. On the other hand, in the white portion, the atomic concentrations of Si, N, and Ti are high, and silicon nitride and Ti are mixed. From these results, it was confirmed that a large amount of silicon nitride and a small amount of the auxiliary agent metal (Ti) were mixed in the solid (powder) obtained by the hydrochloric acid treatment of Comparative Example 1.

### Comparative Example 2

High-temperature and high-pressure treatment and solid-liquid separation were performed in the same manner as in Examples except that 10 g of a 10% by weight aqueous nitric acid solution was used as the acidic liquid instead of the aqueous hydrofluoric acid solution. Table 1 shows the type, liquid amount, and concentration (acid concentration) of the treatment liquid, the size of the sintered body, the amount of the sintered body, and the treatment time.

Each of the filtrate and solid obtained by the solid-liquid separation was analyzed by a method described below.

For the filtrate, particles in the filtrate were removed in the same manner as in Examples. Next, the metal ion concentrations of Er³⁺, Y³⁺, Hf⁴⁺, Ti⁴⁺, and Si⁴⁺ in the filtrate were measured by ICP-MS. The measured value is compared with the reference concentration, and the value (%) of each metal ion concentration of the filtrate in a case where the reference concentration is 100% is shown as the solubility (%) of each metal element in Table 2. The reference concentration was calculated for each type of Si₃N₄ as the main component and each auxiliary agent. Each reference concentration is each metal ion concentration (mol/L) in a case where the main component and each auxiliary agent contained in the amount (0.0367 g) of the silicon nitride ceramic sintered body used in Examples are each completely dissolved in 10 g of a 10% by weight aqueous nitric acid solution.

As is apparent from the results shown in Table 5, it is found that Er₂O₃, Y₂O₃, HfO₂ and TiO₂ as the auxiliary agents were dissolved in the aqueous nitric acid solution by the nitric acid treatment of Comparative Example 2, but that Si₃N₄ as the main component was hardly dissolved in the nitric acid.

On the other hand, the solid was washed and dried by heating in the same manner as in Examples, and then subjected to SEM-EDX observation. From the secondary electron image and the reflected electron image (both magnification: 1000 times) by SEM, it was confirmed that a rod-shaped crystal of β-Si₃N₄ remained. In an electron image obtained by magnifying the reflected electron image 5000 times, mapping analysis by EDX was performed on each of a gray portion where the rod-shaped crystal was present and a white portion where the rod-shaped crystal was not present, and the results are shown in Table 5.

TABLE 5
Table 5: EDX analysis results of Comparative Example 2
Table 5: EDX analysis results of Comparative Example 2

| Table 5 | Element | C | O | Si | N | Er | Y | Hf | Ti |
|---|---|---|---|---|---|---|---|---|---|
| Gray rod- | Atomic | 3.5 | 3.6 | 53.6 | 37.7 | 0.2 | 0.0 | 0.0 | 0.6 |
| shaped crystal | concentration | | | | | | | | |
| | (%) | | | | | | | | |
| White | Atomic | 1.4 | 12.6 | 35.5 | 13.7 | 15.5 | 3.9 | 17.3 | 0.1 |
| portion | concentration | | | | | | | | |
| | (%) | | | | | | | | |

As is clear from the results shown in Table 5, in the gray portion, the total atomic concentration of Si and N exceeded 908, and it was confirmed that the gray portion was almost constituted by silicon nitride. On the other hand, in the white portion, the atomic concentrations of Si, N, Er, Y, and Hf were high, and silicon nitride, Er, Y, and Hf were mixed. From these results, it was confirmed that a large amount of silicon nitride and small amounts of the auxiliary agent metals (Er, Y, Hf, etc.) were mixed in the solid (powder) obtained by the nitric acid treatment of Comparative Example 2.

### Comparative Example 3

High-temperature and high-pressure treatment and solid-liquid separation were performed in the same manner as in Examples except that 10 g of a 10% by weight aqueous sulfuric acid solution was used as the acidic liquid instead of the aqueous hydrofluoric acid solution. Table 1 shows the type, liquid amount, and concentration (acid concentration) of the treatment liquid, the size of the sintered body, the amount of the sintered body, and the treatment time.

Each of the filtrate and solid obtained by the solid-liquid separation was analyzed by a method described below.

For the filtrate, particles in the filtrate were removed in the same manner as in Examples. Next, the metal ion concentrations of Er³⁺, Y³⁺, Hf⁴⁺, Ti⁴⁺, and Si⁴⁺ in the filtrate were measured by ICP-MS. The measured value is compared with the reference concentration, and the value (%) of each metal ion concentration of the filtrate in a case where the reference concentration is 100% is shown as the solubility (%) of each metal element in Table 2. The reference concentration was calculated for each type of Si₃N₄ as the main component and each auxiliary agent. Each reference concentration is each metal ion concentration (mol/L) in a case where the main component and each auxiliary agent contained in the amount (0.0367 g) of the silicon nitride ceramic sintered body used in Examples are each completely dissolved in 10 g of a 10% by weight aqueous sulfuric acid solution.

As is apparent from the results shown in Table 2, it is found that Er₂O₃, Y₂O₃, HfO₂ and TiO₂ as the auxiliary agents were dissolved in the aqueous sulfuric acid solution by the sulfuric acid treatment of Comparative Example 3, but that Si₃N₄ as the main component was hardly dissolved in the sulfuric acid.

On the other hand, the solid was washed and dried by heating in the same manner as in Examples, and then subjected to SEM-EDX observation. From the secondary electron image and the reflected electron image (both magnification: 1000 times) by SEM, it was confirmed that a rod-shaped crystal of β-Si₃N₄ remained. In an electron image obtained by magnifying the reflected electron image 5000 times, mapping analysis by EDX was performed on each of a gray portion where the rod-shaped crystal was present and a white portion where the rod-shaped crystal was not present, and the results are shown in Table 6.

TABLE 6
Table 6: EDX analysis results of Comparative Example 3
Table 6: EDX analysis results of Comparative Example 3

| Table 6 | Element | C | O | Si | N | Er | Y | Hf | Ti |
|---|---|---|---|---|---|---|---|---|---|
| Gray rod- | Atomic | 3.7 | 1.0 | 46.2 | 48.8 | 0.0 | 0.0 | 0.0 | 0.3 |
| shaped crystal | concentration | | | | | | | | |
| | (%) | | | | | | | | |
| White | Atomic | 4.2 | 0.1 | 44.8 | 46.1 | 0.2 | 0.1 | 0.1 | 4.4 |
| portion | concentration | | | | | | | | |
| | (%) | | | | | | | | |

As is clear from the results shown in Table 6, in the gray portion, the total atomic concentration of Si and N exceeds 90%, and it is found that the gray portion was almost constituted by silicon nitride. On the other hand, in the white portion, the atomic concentrations of Si, N, and Ti are high, and silicon nitride and Ti are mixed. From these results, it was confirmed that a large amount of silicon nitride and small amounts of the auxiliary agent metals (Ti and the like) were mixed in the solid (powder) obtained by the sulfuric acid treatment of Comparative Example 3.

Comparison of the results of Examples and Comparative Examples 1 to 3 shows that fluorides of Y and Er can be obtained by bringing a ceramic sintered body containing a main component containing silicon nitride and rare earth elements including Y and Er into contact with an aqueous solution containing fluoride ions and hydrogen ions in a pressure atmosphere at a temperature of from 100° C. to 400° C.

According to the method according to at least one embodiment described above, a ceramic sintered body containing at least one selected from the group consisting of silicon nitride, silicon carbide, and zirconium oxide, and at least one rare earth element (first rare earth element) selected from the group consisting of Y, Er, Ce, and La is brought into contact with an aqueous solution containing fluoride ions and hydrogen ions in a pressure atmosphere at a temperature of from 100° C. to 400° C. to generate a fluoride of the first rare earth element. By solid-liquid separation, the fluoride of the first rare earth element can be efficiently collected from the obtained mixture at low cost.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for recycling a rare earth element, the method comprising:
bringing a ceramic sintered body comprising at least one selected from the group consisting of silicon nitride, silicon carbide, and zirconium oxide, and at least one rare earth element selected from the group consisting of Y, Er, Ce, and La into contact with an aqueous solution comprising fluoride ions and hydrogen ions in a pressure atmosphere at a temperature of from 100° C. to 400° C. to generate a fluoride of the rare earth element; and
separating the fluoride of the rare earth element by solid-liquid separation.

2. The method for recycling a rare earth element according to claim 1, wherein a pressure of the pressure atmosphere is from 0.23 MPa to 40 MPa.

3. The method for recycling a rare earth element according to claim 1, wherein the pressure atmosphere comprises water vapor.

4. The method for recycling a rare earth element according to claim 1, wherein the ceramic sintered body comprises a main component comprising silicon nitride and an auxiliary agent comprising at least one rare earth element of Y or Er.

5. The method for recycling a rare earth element according to claim 1, wherein the ceramic sintered body comprises as a main component the at least one selected from the group consisting of silicon nitride, silicon carbide, and zirconium oxide, and as an auxiliary agent at least one first rare earth element selected from the group consisting of Y, Er, Ce, and La.

6. The method for recycling a rare earth element according to claim 5, wherein the auxiliary agent further comprises at least one second rare earth element selected from the group consisting of Sc, Pr, Nd, Pm, Sm, Eu, Gd, Tb, Dy, Ho, Tm, Yb, and Lu.

7. The method for recycling a rare earth element according to claim 1, wherein the aqueous solution comprises an aqueous hydrofluoric acid solution, a mixed aqueous solution containing NH₄F and H₂SO₄, and a mixed aqueous solution containing NH₄F and HCl.

8. The method for recycling a rare earth element according to claim 7, wherein an acid concentration of the aqueous solution is from 1% by weight to 49% by weight.

9. The method for recycling a rare earth element according to claim 1, wherein a time for treatment in the pressure atmosphere is from 5 hours to 150 hours.

10. The method for recycling a rare earth element according to claim 1, wherein the ceramic sintered body has a powder shape having a size of 1 mm or less.
